(19) United States
(12) Patent Application Publication
(10) Pub. No.: US 2006/0026841 A1
(43) Pub. Date: Feb. 9, 2006

(54) Razors

(76) Inventor: Dirk Freund, Kelkheim (DE)

Correspondence Address: FISH & RICHARDSON P.C., P.O. BOX 1022, MINNEAPOLIS, MN, 55440-1022, US

(21) Appl. No.: 10/914,658

(22) Filed: Aug. 9, 2004

(51) Int. Cl. B26B 21/00

(52) U.S. Cl. 30/32

(57) ABSTRACT

Razors are provided that include (a) a handle, (b) a cartridge having a body, the body having a surface for engaging the skin of the user and having at least one blade mounted therein, (c) a coupling constructed to pivotably mount the cartridge on the handle so that the cartridge may rotate about an axis generally parallel to the surface of said cartridge body which engages the skin of the user, and, (d) within the handle, a controller including a coil configured for non-contacting transmission and reading of data from the cartridge. Cartridges for such razors, and methods of using such razors and cartridges are also provided.

### TECHNICAL FIELD

This invention relates to wet shaving razors, and handles and cartridges for such razors.

### BACKGROUND

Wet shaving devices may be provided with a battery-powered vibrating function. Reciprocating, vibrating, or oscillating motion razors, referred to collectively herein as “vibrating razors,” are described, for example, in U.S. Pat. Nos. 5,046,249, 5,299,354, 5,794,342 and 6,481,104, the disclosures of which are incorporated herein by reference. Some vibrating razors include a rotary motor with an eccentric element for imparting oscillating motion. Other forms of electrical devices may also be provided in wet shaving devices. For example, U.S. 2002/0189102 describes a razor including force sensors and an indicator configured to signal when the blades of the razor need to be replaced. During travel, the vibrating action or other electrical functions of such razors may be turned on inside the user's suitcase. As a result, the battery may be exhausted during storage or transport of the razor.

Many wet shaving razors include a blade unit, commonly referred to as a cartridge, that is removably mounted on the handle so that the blade unit can be replaced by a new blade unit when the sharpness of the blades has diminished to an unacceptable level. Some cartridges include special functionality, e.g., an exfoliating and/or a skin-conditioning (lubricating, moisturizing, etc) surface. Cartridges may also be provided having different shaving characteristics, e.g., different levels of blade sharpness or different numbers of blades.

### SUMMARY

In general, in one aspect, the invention features razors for wet shaving that include a handle, a cartridge, and, within the handle, a controller including a coil configured for non-contacting transmission and reading of data from the cartridge.

The controller may include, for example, a wireless auto-identification electronic device such as an RFID (radio frequency identification device). In some implementations, the razor includes a device configured to perform an electrically-powered function, e.g., heating or vibration, and the controller is configured to control the operation of the function. In these and other implementations, the controller may be configured to identify a characteristic of the cartridge, to detect a condition such as the presence of the cartridge on the handle or contact of the cartridge with water or with human skin, and/or to collect data regarding the usage time associated with the cartridge.

In one aspect, the invention features a wet shaving razor including a handle; a cartridge having a body, the body having a surface for engaging the skin of the user and the body having at least one blade mounted therein; a coupling constructed to pivotably mount the cartridge on the handle so that the cartridge may rotate about an axis generally parallel to the surface of the cartridge body which engages the skin of the user; and, within the handle, a controller including a coil configured for non-contacting transmission and reading of data from the cartridge.

Some implementations may include one or more of the following features. The razor may include a device configured to perform an electrically-powered function, and the controller may be configured to control the operation of the function. The controller may be configured to identify a characteristic and/or a condition of the cartridge. The controller may be configured to collect data regarding the usage time associated with the cartridge. The razor may also include, disposed within or mounted on the cartridge, a data transmission device for cooperative non-contacting transmission of data to the handle. The razor may include a motor disposed within the handle, the motor having a shaft extending therefrom; and an eccentric element fixedly connected to the shaft and disposed for rotation within the hollow neck portion of the handle to cause the cartridge to vibrate, the vibration imparting a motion to the cartridge body so as to reduce the coefficient of friction between the cartridge body and the face of the user to facilitate shaving comfort. The controller may be adapted to transfer and read data only when a cartridge is mechanically coupled to the handle. The coil may be adapted to inductively couple the handle section to the cartridge for transmitting data. The controller may include an ASIC and/or micro-controller. Data may be transmitted between the handle and the cartridge, the data including data specific to the cartridge, e.g., operating parameters for operation of the electrically-powered function. The data may be coded. The data transmission device of the cartridge may include a transponder, e.g., a passive transponder. The handle and the cartridge may be inductively coupled by means of the coil in the handle and the data transmission device in the cartridge, for the exchange or transmission of data or energy. The handle and the cartridge may be capactively coupled.

In another aspect, the invention features a cartridge for a wet shaving razor, including a housing; at least one blade carried by the housing; a mechanical coupling device for coupling the cartridge to a razor handle; and a readable data transmission device having a data carrier and a coil for the non-contacting transmission of data from the cartridge to a coupled razor handle.

Some implementations may include one or more of the following features. The data transmission device may be adapted to be activated by a coupled razor handle. The data transmission device may in some cases transmit data only when the cartridge is mechanically coupled to a razor handle. The data transmission device may be constructed to couple the cartridge to a razor handle inductively. The coil may operate at a resonant frequency of 13.56 MHz, plus or minus 10 percent. The coil may be disposed within, or adjacent to, the mechanical coupling device. The coil may be disposed within the housing. The data transmission device may include a transponder, e.g., a passive transponder. The transponder may have a data memory for digital data.

The invention also features methods of shaving. For example, in one aspect the invention features a method of operating a wet shaving razor having an electrically-powered function, the method including mechanically coupling a removable cartridge to a handle of the razor, such that the handle responds to a data transmission device of the coupled cartridge to enable the electrically-powered function.

Some implementations include one or more of the following advantages. In some implementations, the razor handle includes an operation-inhibiting device that can be activated and/or deactivated via non-contacting data exchange or data transmission. In some implementations, an electrically-powered function of the razor, e.g., a vibrating mechanism, can only be switched on when a compatible cartridge providing an enabling function is attached to the handle and the handle's inhibiting function is deactivated as a result. Unintentional switching on in a travel case or the like can easily be prevented by removing the cartridge from the handle, making premature depletion of the drive's storage battery unlikely. The razor may be configured to perform its electrically-powered function, e.g., to vibrate, only when a certain condition is detected, e.g., the presence of a cartridge mounted on the handle, or contact of the cartridge with water or with human skin.

Data transmitted between the cartridge and handle may include not only data for activating the electrically-powered function but also data specific to the individual cartridge, operating parameters for the electrically-powered function, and/or data specific to the individual user. For example, in some implementations, the razor may be configured to vibrate at different frequencies depending on the type of cartridge mounted on the handle. Some handles are configured to recognize different types of cartridges that could be used with the same handle, e.g., cartridges having exfoliating or moisturizing properties. Operating parameters of the electrically-powered function of the razor may be varied automatically when a cartridge with specific properties is used. For example, if an exfoliating cartridge is detected, the razor may be configured to vibrate at a lower frequency, to avoid excessive exfoliation. The razor handle may also be configured to store information regarding the number of times the cartridge has been used, and duration of use, and provide a signal to the user when the cartridge should be discarded and replaced.

Further advantages, features and application possibilities of the present invention will become apparent from the subsequent Detailed Description and the accompanying drawings.

### DESCRIPTION OF DRAWINGS

FIG. 1 is a partial perspective view of the razor illustrating the razor cartridge and an upper portion of the handle as seen from the rear.

FIG. 2 shows the razor in rear elevation.

FIG. 3 is a perspective view of a razor and accompanying storage tray.

FIG. 4 is an exploded rear elevation of the razor.

### DETAILED DESCRIPTION

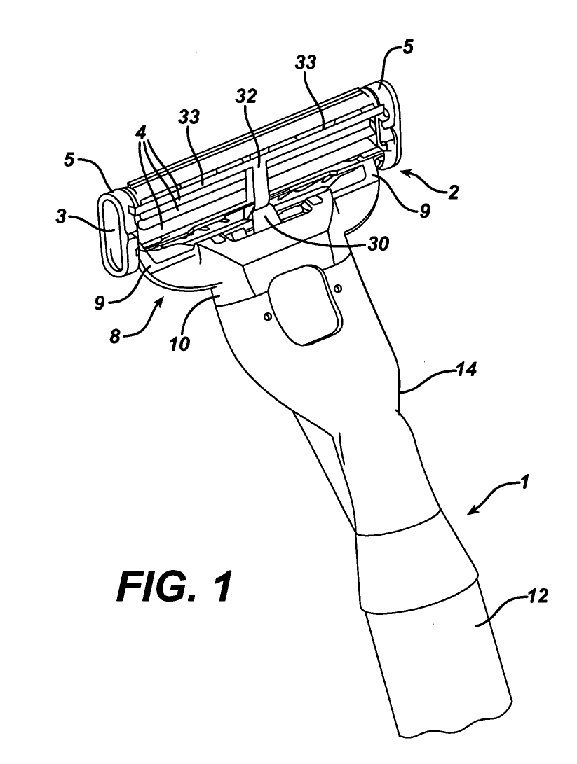

Referring to FIG. 1, a wet shaving razor includes a handle 1 and a blade unit or cartridge 2 detachably mounted on the upper end of the handle. The blade unit 2 includes a generally rectangular frame 3, and a plurality of blades 4, e.g., 3, 4, 5 or more blades. Blades 4 have substantially parallel sharp cutting edges, disposed in the frame and held in place by metal clips positioned around the frame 3 at the opposite ends of the blade unit 2. A guard structure (not shown) including a strip of elastomeric material may be positioned on the front of the blade unit to contact the skin in front of the blades. A cap structure (also not shown) including a lubricating strip may be positioned on the front of the frame to contact the skin behind the blades. The frame 3 is pivotally mounted on a yoke member 8 having a pair of arms 9 which extend from a hub 10 and are journalled in opposite ends of the frame 3 so that the blade unit 2 can pivot relative to the handle about an axis substantially parallel to the blade edges. The hub 10 is detachably connected to the end of the handle.

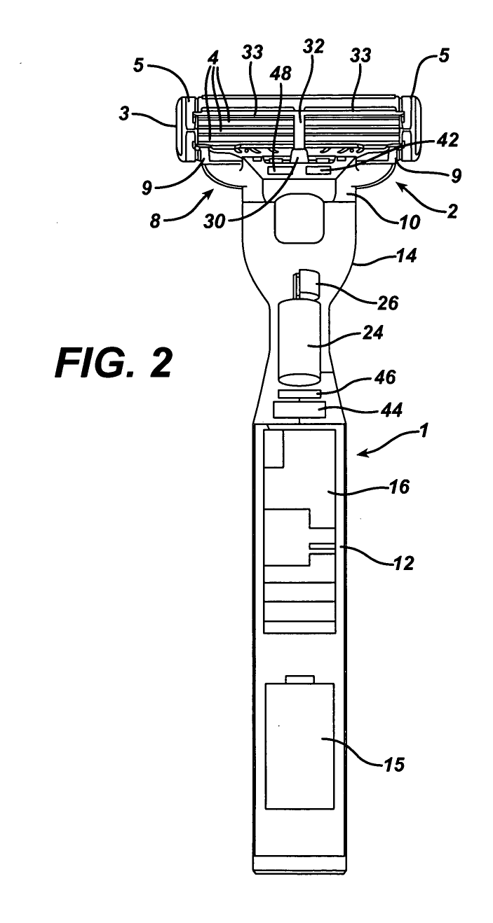

Referring to FIG. 2, the razor handle includes a main portion 12 intended to be gripped in the hand, and a neck 14 extending upwardly from the main portion and to the free end of which the blade unit 2 is attached. Housed within a battery compartment within the handle is a replaceable or rechargeable battery 15, which provides a power supply for an electrical control device 16 that is also within the handle.

The control device 16, described in detail below, controls actuation of one or more electrically-powered functions of the razor. For example, in the case of a vibrating razor, the control device controls actuation of an electric motor 24 (FIG. 2) housed within the handle 1 and having an output shaft with an eccentric weight 26 mounted thereon. As is well known, energization of the motor results in a high speed rotation of the eccentric weight and thereby vibration of the razor and the blade unit in particular. The control device may be configured to control actuation of the motor in response to one or more detected conditions, for example the presence or absence of a cartridge mounted on the handle, contact of the cartridge with skin, and/or contact of the cartridge with water. Vibrating the blade unit as it moves across the skin can have a beneficial effect on shaving performance, and vibration during rinsing may enhance rinsing. However, some users do not like the sensation of vibration when the cartridge is held in space, away from the skin, and thus it may be desirable to limit vibration to when the razor is actually shaving and/or to when the blade unit is being rinsed.

Other electrically-powered functions that may be controlled by the control device include heating, exfoliating, and/or application of a skin-conditioning (lubricating or moisturizing) composition.

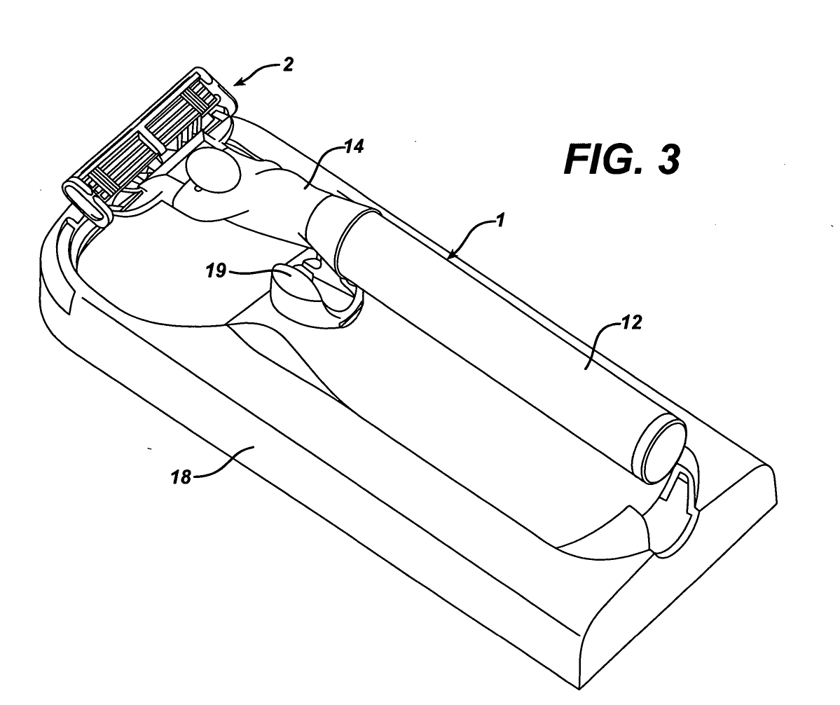

The battery 15 may be electrically connected to the control device 16 through a power switch which is operable to interrupt power supply to the control device for conserving battery energy during periods when the razor is not being used. For example, if the control device is configured to shut off the electrical functions of the razor only when the cartridge is removed, as will be discussed in detail below, it may be desirable for the user to have the option to manually shut off the razor if the user wishes to store the razor with the cartridge in place. The switch may be positioned to be manually actuated by the user, or to be automatically actuated when the razor is inserted into a storage tray, e.g., storage tray 18 (FIG. 3). Storage tray 18 includes a saddle 19 adapted to receive and lightly grip the neck 14 of the razor handle 1, and may include a permanent magnet (not shown) configured to open a reed switch (also not shown) in the handle when the razor is placed on the storage tray. Other types of switch/tray arrangements may be used.

The control device 16 may include a printed circuit board with a microprocessor or an ASIC or other electrical components. As will be discussed in further detail below, the control device 16 may include, in some implementations, an operation inhibiting device which inhibits or permits switching on of the electrically-powered function only when or after a compatible cartridge is attached to the handle. The operation inhibiting device is activated and deactivated by an enabling element provided on the cartridge. The enabling element can have a coding, e.g., an electronic key. To identify the respectively attached cartridge, provision is made on the handle for a coding/detecting device for detecting the presence of the enabling element.

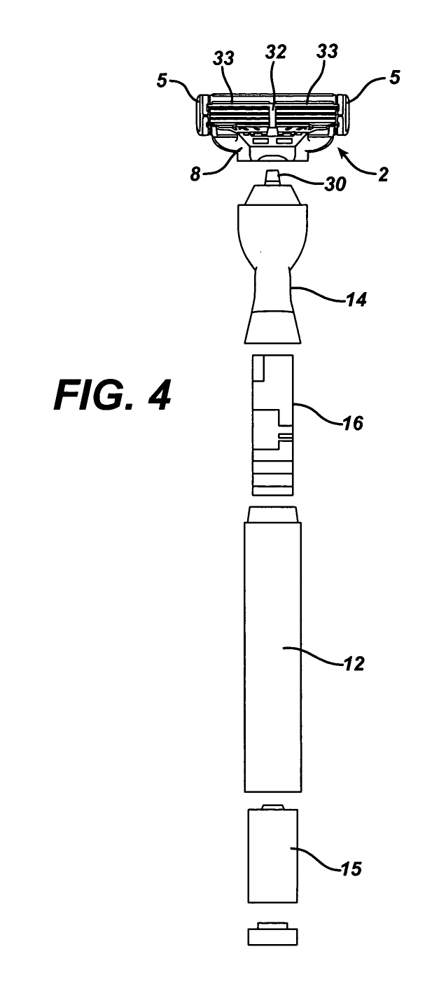

FIGS. 1-4 show a razor with wireless data transfer between cartridge and handle, in which the presence of the respective cartridge coupled to the handle and/or properties of the cartridge may be detected or determined via digital signals. Referring to FIG. 2, the cartridge is equipped with a transponder 42 which can be embedded in the frame or the yoke, or bonded by an adhesive on or to the cartridge as in the form of a label referred to as smart label. Provided in the handle is a detector or reading device 44 which is tuned to the transponder 42 and serves both as a signal transmitter and signal receiver. The detector or reading device 44 in the handle first transmits electromagnetic waves via a coil 46 to a coil 48 connected to the transponder 42 in order to supply the transponder 42 or its microchip with energy for activation. Coil 48 may be embedded in or printed on the frame or yoke, or attached to the cartridge in any desired manner. The transponder 42 stores the energy, is activated and transmits a specific, stored ID or signal or data back to the detector or reading device 44, which receives the ID, signal or data, identifies it by means of an electronic evaluating unit 50 and emits a corresponding signal to the control device 16 or inhibiting device of the handle section 10. The coils 46 and 48 can be operated as both a transmitter and receiver. The cartridge can be identified, or its presence on the handle 10 recognized, by means of the ID or data sent back from the transponder 42.

Load modulation may be employed to detect whether the cartridge is in contact with the skin. When the load on the transponder coil 48 is changed, it will modulate the change to the reading device 44. Skin contact can be sensed by altering the load of the transponder-coil system in the cartridge with the bio-impedance of the human body. Alternatively, the reading device 44 may generate an electrical field that is capacitively coupled to the cartridge while a resonant circuit in the reading device generates the power supply for the transponder. The bio-impedance of the body dampens the resonant circuit, allowing skin contact to be detected. Sensing electrodes are also required, and can be positioned on a skin-contacting surface of the cartridge frame. The electrodes may be formed in any desired manner, e.g., of metal or conductive ink.

Detector or reading device 44 may include an RFID (radio frequency identification device). The RFID is provided in the handle section of the razor in order to implement the enabling function by detecting the data from the transponder provided in the cartridge and transmitted in a non-contacting manner. The RFID and the transponder (or other non-contacting data carrier) each have a coupling element, which can be a coil, as discussed above, or other element such as a microwave antenna. Data, clock pulses and/or energy are exchanged via these coupling elements between the reading device and the non-contacting data carrier. It is thus possible, by means of the reading device, which is also referred to as a transceiver (transmitter/receiver) to receive data or information from the transponder. Conversely, it is also possible to use the reading device to write data into the transponder. Thus, for example, data may be written into the transponder data concerning, for example, the period of use for an individual cartridge so that when a certain maximal shaving period has elapsed the user can be reminded to replace the cartridge with a new one. The cartridge may include a data or information memory, e.g., for storing digital information.

Generally, energy is transmitted from the reading device to the transponder, as discussed above, when the transponder is of the passive type, i.e., is a transponder without an energy supply of its own. The energy transmitted from the reading device to the transponder is then used for activation of the transponder. In the event of an active transponder being used, meaning a transponder with its own energy supply, for example a button cell as a battery or the like, it will be understood, of course, that the transmission of energy to activate the transponder is not necessary.

An inductive or magnetic coupling is preferably provided as an element for the non-contacting coupling of the reading device and transponder. Such couplings are generally referred to as inductive radio systems or inductively coupled short range devices. The operating frequency may be, for example, 13.56 MHz. The transponder itself can be configured as a 1-bit or multi-bit transponder. The transmission of information or data between the transponder and the reading device is preferably performed by means of a load modulation in the transponder, for which purpose a load resistor is switched on or off in the transponder at a cycle frequency or certain pulse train, thus producing a reaction or feedback in the reading device via the inductive coupling, enabling the data to be transmitted from the transponder to the reading device and vice versa.

The enabling element or enabling function on the cartridge for deactivating the operation inhibiting device or function can be configured so that only the presence or absence (1-bit information) of a cartridge on the handle section is detectable. To this effect, for example, an acting member may be arranged in the cartridge which corresponds with a reacting member in the handle, in such manner that with the cartridge and the handle in coupled condition the reacting member receives from the acting member a preferably digital signal and deactivates, for example, the inhibiting device provided. This provides a simple travel security function, preventing the electrical function(s) of the razor from operating when the cartridge is not attached. Accordingly it is sufficient to decouple the cartridge from the handle to activate the travel security function. The coding/detecting device may also be configured so as to enable the coupling of a cartridge allowing for distinction between various different cartridges (multi-bit information). A coding and/or detecting device allowing, for example, the identification of two, four or six different codings of the cartridge enables further functions to be performed in addition to the travel security function. Thus, for example, the coding/detecting device may be configured to distinguish between a cartridge having an exfoliating function and one that does not include such a functionality.

The inhibiting device 36, the reading device 44 and an electronic evaluating unit 50 are generally part of the control device 18, which can be configured as an ASIC, for example. The control device may include a micro-controller or microprocessor and, where applicable, further electronic components or only one discrete circuit. It will be understood, of course, that the electronic components, that is, the control device 16, the inhibiting device 36, the reading device 44 and the electronic evaluating unit 50, can also be implemented by discrete electronic components if desired.

It is generally preferred that the coil 46 be adjacent or in close proximity to the area of the mechanical coupling device 30 of the handle. The coil 46 is positioned relative to coil 48 so that when the cartridge is properly mechanically coupled to the handle the coupling of the coils 46, 48 or the coupling factor is such that data can be transferred between the cartridge and the handle.

Basically it is possible for the coils 46, 48 to be positioned in any position on the handle section 10 and, respectively, the cartridge 2, provided adequate coupling between the coils 46, 48 exists when the cartridge is mechanically coupled correctly to the handle so that the control device provided in the handle can communicate with or receive data from the enabling element 38 or transponder 42 provided in the cartridge via an electric and/or magnetic, in particular inductive coupling.

The basic architecture of a control device 18 or a reading device 44 as well as of the enabling element 38 or transponder 42 is generally known. In this context, reference is made to the text book “RFID-Handbuch, Grundlagen und praktische Anwendung induktiver kontaktloser Chipkarten” by Klaus Finkenzeller, 2nd edition, November 1999, Karl Hansa Verlag Munchen, ISBN 3-446-2278-7, in particular to chapter 3, which is incorporated by reference herein. In addition to the coil 46, the reading device includes a capacitor as resonant circuit and a generator that operates this resonant circuit at roughly its resonant frequency, for example in the range of between 13 and 14 megahertz, for example at 13.56 megahertz or also at 125 kilohertz, plus or minus 10 kilohertz. Connected to this circuit arrangement is an electronic evaluating unit whose signals, amplified if necessary by means of an amplifier, are fed to the inhibiting device 36. Further signals can be fed to the inhibiting device 36 as input values if so required. An output signal of this inhibiting device 36 is used to enable or inhibit the electrical function(s) of the razor, depending on whether a corresponding data transfer has taken place or not.

Provided in or on the cartridge 2 is the coil 48, to which a capacitor is connected. The two components likewise form a resonant circuit which is tuned to the transmit or resonant frequency of the resonant circuit of the reading device 44. Also provided are a rectifier, for example, a diode, and an energy storage device, for example, a capacitor, which supplies the transponder 42 with the energy necessary for it to operate, drawn from the high-frequency electromagnetic field radiated by the coil 46. It is also possible for a micro-controller to be provided in the transponder 42, which at least partly opens and closes a switching device inserted parallel to the resonant circuit capacitor or coil 48, for example, a FET, as a load resistor of the transponder resonant circuit. The clock frequency of these opening and closing cycles can lie, for example, in the 1 kHz to 100 kHz range, for example, at about 5 kHz, about 20 kHz or at about 212 kHz. By providing for switching on and off (modulating) of the load resistor in the transponder 42 at a clock frequency lying far below the resonant frequency, there arise in the reading device 44 sidebands adjacent to the transmit or resonant frequency of the resonant circuit of the reading device 44, which can be readily detected with a bandpass filter, for example, resulting in an improved signal-to-noise ratio. It is also possible, preferably at low clock frequencies in the range between 1 kHz and 50 kHz, to use an envelope demodulator or the like for demodulation. With this clock frequency it is also possible to transmit a multiplicity of data from the transponder 42 to the reading device 44, the data being defined by the clock rate or pulse train, the pulse duty factor or the pulse repetition frequency. Ultimately these approaches amount to a load modulation by means of a subcarrier on the transponder 42, as the result of which the reaction of the transponder 42 to the reading device 44 can be simply and easily detected by means of known demodulation processes (for example, amplitude shift keying (ASK) with and without sideband). For further details reference is made to the previously mentioned RFID manual. Furthermore, the reading device will generally need to be adapted accordingly if there is no load modulation of the transponder resonant circuit and the phase (phase shift keying) or frequency (frequency shift keying) is modulated.

The coils themselves can be conventional, wire-wound coils, with the exemplary data for coil 46 being about 10, plus or minus 3 turns at a turn diameter of about 15, plus or minus 3 mm and a wire thickness of about 0.1 mm. The inductance can be approximately 2 μH, and the ohmic resistance may be approximately 1 ohm. For coil 48, 15 plus or minus 4 turns at a turn diameter of 9 plus or minus 2 mm and a wire thickness of, for example, 0.06 mm can be provided. The inductance then lies in the range of about 2 μH to about 8 μH, preferably at about 5 μH at an ohmic resistance of the coil of about 1 ohm to about 10 ohm, preferably about 4 ohm. It will be understood, of course, that the coils 46, 48 can be constructed as conventional wire-wound coils or, alternatively, in the form of turns printed, for example, on a flexible plastic foil or on the transponder chip itself. The coupling of the two coils 46, 48 with properly mechanically coupled handle and cartridge can lie between 1 percent and 8 percent, preferably at about 5 percent, the coupling of the coils 46, 48 being primarily of the inductive type in the present embodiment and with the frequencies in the two-digit MHz range therein employed. The diameter of the coils generally should not be less than 3 mm, approximately. The quality factor of the transponder resonant circuit should be between about 5 and 15, preferably between about 8 and 10, in order to minimize the dependence on tolerance-related fluctuations of the resonant frequency, particularly with regard to the phase shift. The quality factor is defined, among other things, by the wire thickness of the coil 48.

The data or information memory of the cartridge, in particular transponder 42, and the data or information reader 44 in the handle are commercially available as standard items in a wide variety of different specifications. For pertinent details reference is again made to the previously mentioned RFID manual. It is also possible, of course, to include the data reader 44 in a user-specific integrated circuit (ASIC) provided in the handle.

Other embodiments are within the claims.

For example, while the acting member is typically provided in the cartridge, it may be made available to the end user as a separate, isolated part or may be provided on the handle itself. This approach may be suitable, for example, when the end user is already in possession of a handle equipped with an operation inhibiting device but has a household supply of cartridges available which are not equipped with an enabling element or an acting member for deactivation of the inhibiting function of the handle. This makes it possible, for example, for the end user to fasten an enabling element or acting member directly to the handle equipped with the inhibiting device, as on the exterior of the housing in the area of the reacting member of the handle section, and to deactivate for such special or exceptional cases the inhibiting device of the handle section by arranging the acting member on the handle section itself and not on the cartridge. This solution may also be contemplated when for cost reasons, for example, not all of the replacement cartridges compatible or mechanically mating with the handle section or handhold are equipped with such an enabling element, a coding device or an acting member. It will be understood, of course, that the solution involving the fastening of the enabling element directly to the handle section as by its user is an exceptional situation, and that as a rule the enabling element should be arranged on the cartridge.

Moreover, other types of cartridges may be used, for example cartridges in which the blades are retained without clips, e.g., by insert molding. Any desired cartridge geometry and cartridge features may be utilized.

What is claimed is:

1. A wet shaving razor comprising:
a handle;
a cartridge having a body, said body having a surface for engaging the skin of the user and said body having at least one blade mounted therein;
a coupling constructed to pivotably mount the cartridge on the handle so that the cartridge may rotate about an axis generally parallel to the surface of said cartridge body which engages the skin of the user; and
within the handle, a controller including a coil configured for non-contacting transmission and reading of data from the cartridge.

2. The razor of claim 1 wherein the razor includes a device configured to perform an electrically-powered function, and the controller is configured to control the operation of the function.

3. The razor of claim 1 wherein the controller is configured to identify a characteristic of the cartridge.

4. The razor of claim 1 wherein the controller is configured to detect a condition of the cartridge.

5. The razor of claim 4 wherein the condition is selected from the group consisting of the presence of the cartridge on the handle, contact of the cartridge with water, and contact of the cartridge with human skin.

6. The razor of claim 4 wherein the controller is configured to collect data regarding the usage time associated with the cartridge.

7. The razor of claim 1 further comprising, disposed within or mounted on the cartridge, a data transmission device for cooperative non-contacting transmission of data to the handle.

8. The razor of claim 1 further comprising a motor disposed within the handle, the motor having a shaft extending therefrom; and an eccentric element fixedly connected to the shaft and disposed for rotation within the hollow neck portion of the handle to cause the cartridge to vibrate, said vibration imparting a motion to said cartridge body so as to reduce the coefficient of friction between said cartridge body and the face of the user to facilitate shaving comfort.

9. The razor of claim 8 wherein the blade(s) is (are) resiliently mounted and biased relative to the skin-engaging surface.

10. The razor of claim 9 wherein the resilient mounting is configured to substantially damp the vibration transmitted to the blade(s) and thereby reduce the motion of the blade(s) in the direction generally perpendicular to the surface of the cartridge body which engages the face of the user so as to reduce chopping action of the blades against the hairs of the beard to be shaved

11. The razor of claim 1 wherein the handle includes a hollow tube portion open at its proximal end to provide a battery compartment to permit the insertion of a battery therein.

12. The razor of claim 11 further comprising a cover removably mounted in the proximal end of the handle body to seal the battery compartment.

13. The razor of claim 8 further comprising a battery operatively connected to the motor.

14. The razor of claim 1, wherein the controller is adapted to transfer and read data only when a cartridge is mechanically coupled to the handle.

15. The razor of claim 1, wherein the coil is adapted to inductively couple the handle section to the cartridge for transmitting data.

16. The razor of claim 1, wherein the controller includes an ASIC and/or micro-controller.

17. The razor of claim 1, wherein data is transmitted between the handle and the cartridge, the data including data specific to the cartridge.

18. The razor of claim 2, wherein the transmitted data includes operating parameters for operation of the electrically powered function.

19. The razor of claim 1, wherein data is transmitted between the cartridge and the handle and wherein the data is coded.

20. The razor of claim 7, wherein the data transmission device of the cartridge comprises a transponder.

21. The razor of claim 20, wherein the transponder is passive, and wherein energy is transmitted from the handle to the cartridge to activate the passive transponder.

22. The razor of claim 7, wherein the handle and the cartridge are inductively coupled by means of the coil in the handle and the data transmission device in the cartridge, for the exchange or transmission of data or energy.

23. The razor of claim 1 or 22 wherein the handle and the cartridge are capacitively coupled.

24. A cartridge for a wet shaving razor, comprising:
a housing;
at least one blade carried by the housing;
a mechanical coupling device for coupling the cartridge to a razor handle; and
a readable data transmission device having a data carrier and a coil for the non-contacting transmission of data from the cartridge to a coupled razor handle.

25. The cartridge of claim 24, wherein the data transmission device is adapted to be activated by a coupled razor handle.

26. The cartridge of claim 24, wherein the data transmission device transmits data only when the cartridge is mechanically coupled to a razor handle.

27. The cartridge of claim 24, wherein the data transmission device is constructed to couple the cartridge to a razor handle inductively.

28. The cartridge of claim 24 further comprising a capacitor for capacitive coupling of the cartridge to a razor handle.

29. The cartridge of claim 24, wherein the coil operates at a resonant frequency of 13.56 MHz, plus or minus 10 percent.

30. The cartridge of claim 24, wherein the coil is disposed within, or adjacent to, the mechanical coupling device.

31. The cartridge of claim 24, wherein the coil is disposed within the housing.

32. The cartridge of claim 24, wherein the data transmission device comprises a transponder.

33. The cartridge of claim 32, wherein the transponder is passive.

34. The cartridge of claim 32, wherein the transponder has a data memory for digital data.

35. A method of operating a wet shaving razor having an electrically-powered function, the method including mechanically coupling a removable cartridge to a handle of the razor, such that the handle responds to a data transmission device of the coupled cartridge to enable the electrically-powered function.

36. The method of claim 35, wherein the handle includes a reader that inductively couples to the data transmission device of the cartridge, for communication between the cartridge and handle in a non-contacting manner.

37. The method of claim 36 wherein the reader and data transmission devices contain respective communication coils.
